(19) United States
(12) Patent Application Publication
(10) Pub. No.: US 2024/0428454 A1
(43) Pub. Date: Dec. 26, 2024

(54) METHOD FOR DETERMINING A TARGET POSITION

(71) Applicant: Siemens Aktiengesellschaft, 80333 München (DE)

(72) Inventors: JOHANNES BENKERT, Fürth (DE); ALOIS RECKTENWALD, Herzogenaurach (DE); JULIAN VOGEL, Erlangen (DE)

(73) Assignee: Siemens Aktiengesellschaft, 80333 München (DE)

(21) Appl. No.: 18/696,197

(22) PCT Filed: Aug. 25, 2022
(86) PCT No.: PCT/EP2022/073636

§ 371 Date: Mar. 27, 2024

(30) Foreign Application Priority Data
Sep. 28, 2021 (EP) 21199484.3

(51) Int. Cl. G06T 7/73; G06T 3/06

(52) U.S. Cl. CPC G06T 7/75; G06T 3/06; G06T 2207/10028; G06T 2207/20084

(57) ABSTRACT

A computer-implemented method for determining a target position in an automated positioning of a load on an object with better performance and shorter calculation times, the object is sensed with a sensor, for example a laser-based sensor, and a 3D point cloud representing the object is created. The 3D point cloud is projected into at least one 2D projection plane, and at least one structure for the positioning of the load by image processing is detected with the aid of neural networks. The 2D projection plane is back-projected into three-dimensional space, and a position of the at least one structure in three-dimensional space is determined.

### DESCRIPTION

The invention relates to a computer-implemented method for determining a target position in the automated positioning of a load on an object.

The invention further relates to a control unit with means for performing such a method.

The invention moreover relates to a computer program for performing such a method on execution in a control unit.

The invention furthermore relates to a positioning system having at least one, in particular laser-based, sensor and a control unit.

The invention additionally relates to a crane having at least one positioning system.

Such a crane is embodied for example as a gantry crane, in particular a container crane, which is also called a container bridge, and is used in a port terminal for loading ISO containers onto trucks and wagons, in particular rail wagons. In container terminals in particular, loading processes with the help of cranes are increasingly automated, in other words without manual intervention by operators.

Published unexamined patent application WO 2020/221490 A1 describes a method for collision-free movement of a load with a crane in a space with at least one obstacle. In order to comply with a safety level as simply as possible, it is proposed that a position of the obstacle is provided, wherein at least one safe state variable of the load is provided, wherein a safety zone surrounding the load is determined from the safe state variable, wherein the safety zone is dynamically monitored in relation to the position of the obstacle.

The academic publication Price Leon C. et al: “Multisensor-driven real-time crane monitoring system for blind lift operations: Lessons learned from a case study” describes a sensor-controlled real-time crane monitoring system consisting of modules for load tracking, obstacle recognition, worker recognition, collision warning and 3D visualization. A combination of encoders, image processing systems and laser scanners is used to reconstruct a 3D workspace model of the crane environment and to provide spatial feedback to the operator in real time.

The academic publication Lee Jaecheul: “Deep learning-assisted real-time container corner casting recognition” describes an automated crane system with efficient recognition of corner pieces.

Against this backdrop, the invention is based on the object of specifying a method for determining a target position in the automated positioning of a load on an object, which, in comparison with the prior art, enables improved performance and shorter calculation times.

The object is inventively achieved by a computer-implemented method for determining a target position in the automated positioning of a load on an object, having the following steps: sensing the object by means of at least of one sensor, creating a 3D point cloud, which represents the object, projecting the 3D point cloud into at least one 2D projection plane, detecting at least one structure for positioning the load by means of image processing, back-projecting the 2D projection plane into the three-dimensional space, determining a position of the at least one structure in the three-dimensional space.

The object is further inventively achieved by a control unit with means for performing such a method.

The object is moreover inventively achieved by a computer program for performing such a method on execution in a control unit.

The object is furthermore inventively achieved by a positioning system with at least one, in particular laser-based, sensor and such a positioning system.

The object is additionally inventively achieved by a crane with at least one such safety system.

The advantages and preferred embodiments set out below in relation to the method can be transferred analogously to the control unit, the computer program, the positioning system and the crane.

The invention is based on the consideration of achieving improved performance and shorter calculation times in a method for determining a target position in the automated positioning of a load on an object, by carrying out a transformation of three-dimensional data into a 2D projection plane. Such a load is for example a container, while the object is for example a truck or at least one further container of a container mountain. In particular, such a container is placed corner to corner on a container mountain or, e.g. by means of twist locks, on a truck. The method entails sensing the object by means of at least one sensor, wherein the sensor is for example embodied as a laser-based sensor. A 3D point cloud, which represents the object, is then created from the sensor data.

In a further step the 3D point cloud of the object is projected into at least one 2D projection plane. Thanks to such a projection a number of the points relevant to the further processing is reduced. In a further step at least one structure for positioning the load is detected by means of image processing in the 2D projection plane. Such a structure is for example a twist lock on a loading bed of a truck or an edge on a container. The 2D projection plane is then back-projected into the three-dimensional space. A position of the at least one structure is then determined in the three-dimensional space. Thanks to the projection of the 3D point cloud for further processing into a 2D projection plane and the back-transformation the calculation time is reduced, without the accuracy being impaired, in particular noticeably. Thanks to such an improvement in performance, industrial use in the crane sector is enabled.

A control unit, which is for example assigned to the crane, has means for performing the method, which for example comprise a digital logic module, in particular a microprocessor, a microcontroller or an ASIC (application-specific integrated circuit). Additionally or alternatively, the means for performing the method comprise a GPU or what is known as an “AI accelerator”.

The computer program can comprise a “digital twin” or can be designed as such, which can comprise, among other things, the 3D point cloud, which represents the object. Such a digital twin is shown for example in published patent application US 2017/0286572 A1. The disclosure content of US 2017/0286572 A1 is incorporated in the present application by reference.

A further form of embodiment provides the following further steps: determining at least one 2D bounding box, which comprises a structure, back-projecting the 2D projection plane inside the at least one 2D bounding box, determining at least one 3D bounding box in the 3D point cloud using the at least one 2D bounding box, determining a position of the at least one structure inside the 3D bounding box. In particular, an area relevant to the structure, for example a twist lock, is detected in the form of a bounding box that encloses it as closely as possible. For example, additional knowledge about typical object sizes and geometrical and/or other process-related relationships can also be taken into consideration in the determination of the 2D bounding box. In particular, such a bounding box can act as a filter, wherein points situated inside this box are part of the structure to be detected or are assigned to the structure to be detected. Such a use of a bounding box additionally reduces calculation time.

A further form of embodiment provides that the detection of the at least one structure for positioning the load is carried out by means of a neural network. For example, a Region Based Convolutional Neural Network (R-CNN), in particular a Faster R-CNN, is used. For example, at least one 2D projection plane is compared with training data of the neural network. Training data can be generated by, among other things, generic learning of reference structures such as twist lock, struts, etc. Using such a neural network a plurality of different structures for positioning the load can be detected simply and reliably.

A further form of embodiment provides that the 2D projection plane has pixels which represent points of the projection, wherein the pixels are assigned at least one channel which comprises height information, a remission and/or information on surface normals. Thanks to the projection onto a 2D projection plane the number of pixels is reduced, leading to a reduction in computing time. By including the height information, the remission and/or the information about surface normals, the accuracy of the detection of the structure is improved, in particular during back-projection into the three-dimensional space. When multiple channels are used, which are for example processed in parallel, it is additionally possible to achieve an improved accuracy.

A further form of embodiment provides that at least two 2D projection planes are determined, which differ in respect of a projection direction. For example, the at least two 2D projection planes are arranged orthogonally to one another. Thanks to at least two 2D projection planes it is possible to achieve an improved accuracy.

A further form of embodiment provides that the projection of the 3D point cloud is carried out in at least two partial planes, which are combined to form the 2D projection plane. This procedure reduces the runtime of the algorithms. The at least two partial planes are for example embodied as square, wherein a square input vector is generated for the neural network. Such a square input vector reduces the calculation time during further processing in the neural network.

A further form of embodiment provides that at least one additional transition plane is determined, which contains a connection region of second partial planes. In particular, since neural networks are more prone to error in an edge region of images and it is advisable to prevent important structures being “cut up” at the edge of a slice, it is possible to achieve an improved accuracy thanks to such transition planes.

A further form of embodiment provides that the object is sensed by means of a laser-based sensor. By means of laser-based sensors it is possible to create a 3D point cloud of an object quickly and cost-effectively.

The invention is described and explained in greater detail below using the exemplary embodiments shown in the figures, in which:

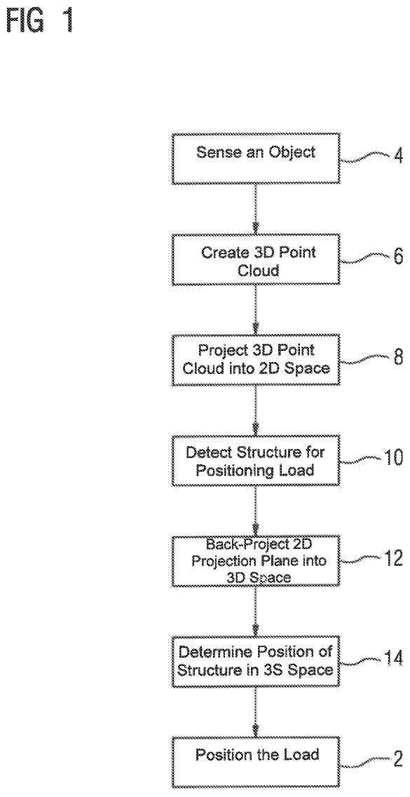

FIG. 1 shows a flow diagram of a method for determining a target position in the automated positioning of a load on an object,

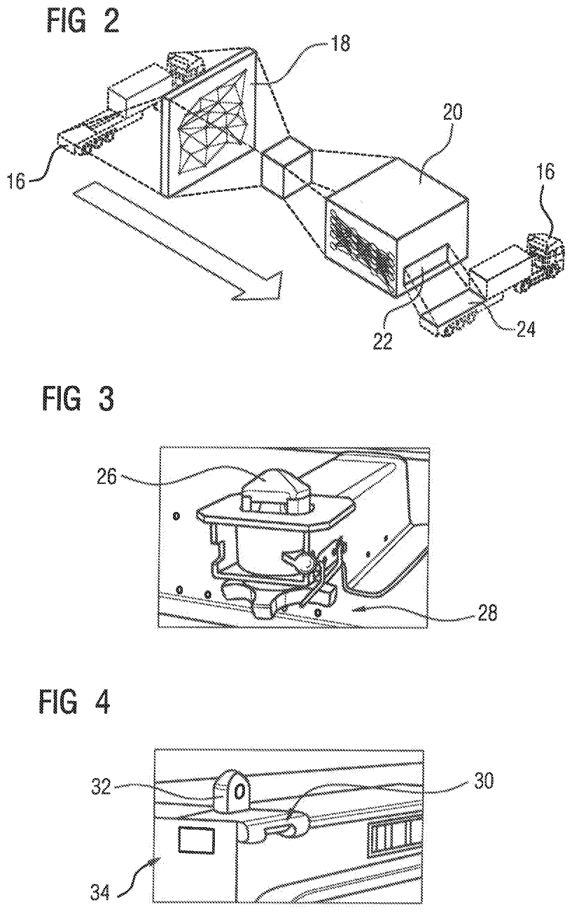

FIG. 2 shows a schematic representation of a method for determining a target position in the automated positioning of a load on an object,

FIG. 3 shows a three-dimensional representation of a twist lock,

FIG. 4 shows a three-dimensional representation of a foldable side board,

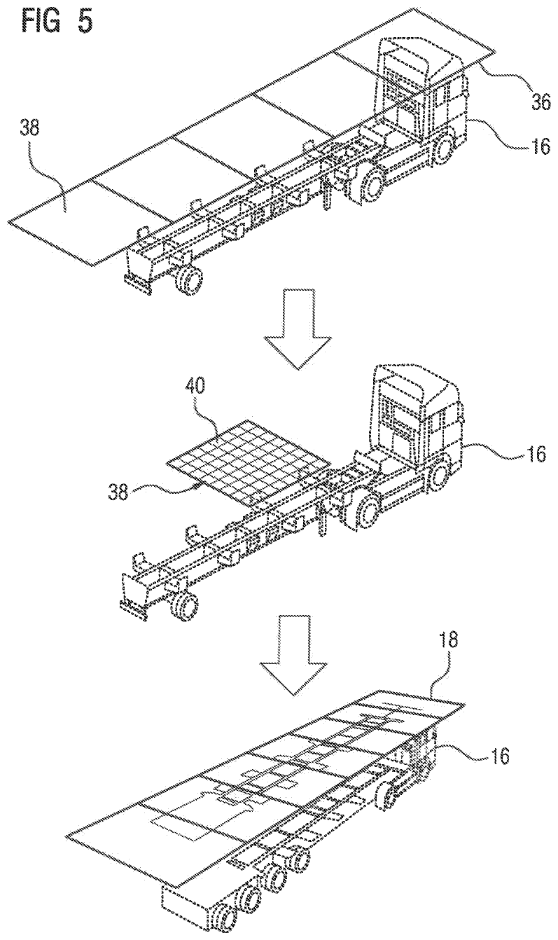

FIG. 5 shows a schematic representation of a second method for determining a target position in the automated positioning of a container on a truck,

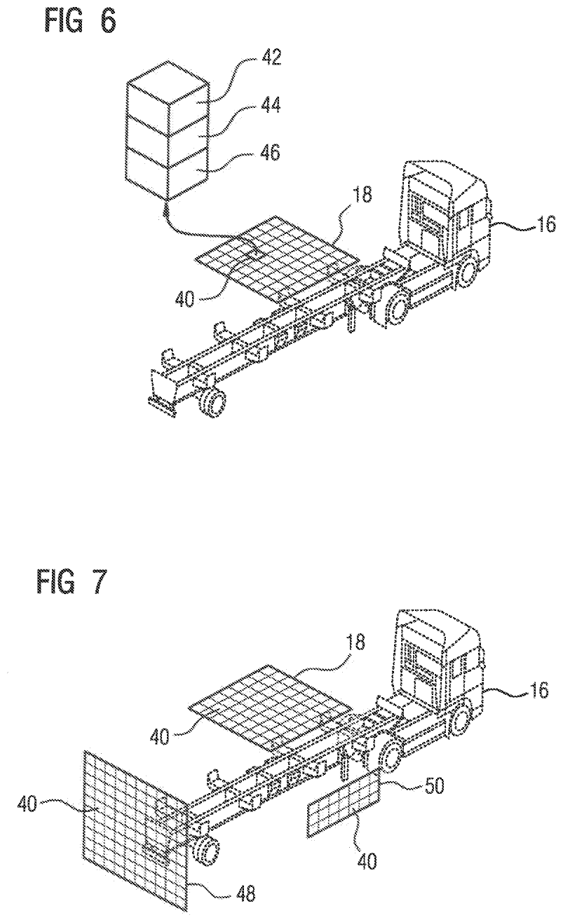

FIG. 6 shows a schematic representation of a third method for determining a target position in the automated positioning of a container on a truck,

FIG. 7 shows a schematic representation of a fourth method for determining a target position in the automated positioning of a container on a truck,

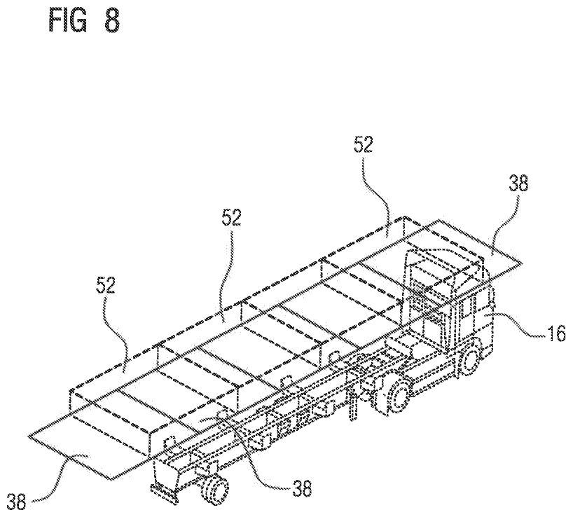

FIG. 8 shows a schematic representation of a fifth method for determining a target position in the automated positioning of a container on a truck,

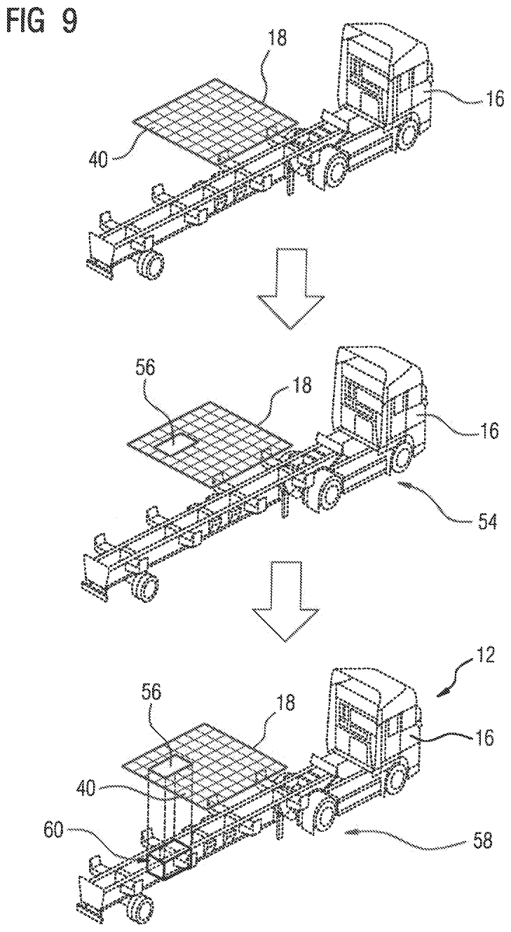

FIG. 9 shows a schematic representation of a sixth method for determining a target position in the automated positioning of a container on a truck and

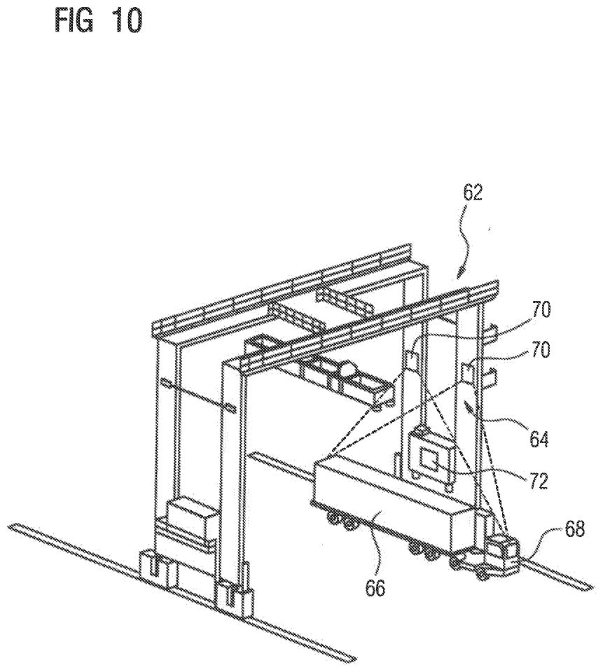

FIG. 10 shows a crane with a positioning system.

The exemplary embodiments explained below relate to preferred forms of embodiment of the invention. In the exemplary embodiments, the described components of the forms of embodiment each represent individual features of the invention that can be considered independently of one another, which each also develop the invention independently of one another and thus are also to be regarded individually or in a combination other than the one shown as part of the invention. Furthermore, the forms of embodiment described can also be supplemented by further features, already described, of the invention.

The same reference characters have the same meaning in the different figures.

FIG. 1 shows a flow diagram of a method for the automated positioning (2) of a load on an object. The positioning 2 of the load is carried out for example by means of a crane on a truck or a container mountain. The method includes sensing 4 the object by means of at least of one sensor. For example, the sensing 4 of the object is carried out by means of a laser-based sensor. This is followed by creation 6 of a 3D point cloud, which represents the object. In a further step a projection 8 of the 3D point cloud into at least one 2D projection plane is carried out. This is followed by the detection 10 of at least one structure for positioning the load by means of image processing, wherein for example data of the 2D projection plane is compared with training data of a neural network. Such a structure is for example a twist lock on a loading bed of a truck. In a further step, back-projection 12 of the 2D projection plane into the three-dimensional space is carried out. Then follows a determination 14 of a position of the at least one structure in the three-dimensional space. This is followed by the actual positioning 2 of the load using the position of the at least one structure.

FIG. 2 shows a schematic representation of a first method for determining a target position in the automated positioning of a container on a truck. A 3D point cloud 16 created by a laser scanner, in particular a 3D laser scanner, is projected into the two-dimensional space. The 2D projection plane 18 of the 3D point cloud 16 is further processed by means of a neural network 20 using machine-learning algorithms of the image processing. For example, a Region Based Convolutional Neural Network (R-CNN) is used, in particular a Faster R-CNN. The neural network 20 can among other things be trained by generic learning of reference structures such as twist locks, struts, etc. By means of such a neural network at least one structure for positioning the load is detected. The result 22 learned from this, in particular the position of the at least one structure, is in a further step transformed back into the three-dimensional space and is passed as at least one target position 24 to the following process, for example the positioning of the load using the position of the at least one structure. The further execution of the method in FIG. 2 corresponds to that in FIG. 1.

FIG. 3 shows a three-dimensional representation of a twist lock, which is provided to lock a container on a loading bed, for example of a truck.

FIG. 4 shows a three-dimensional representation of a foldable side board 30 with a mounting pin 32, which is arranged on a carrying wagon 34.

FIG. 5 shows a schematic representation of a second method for determining a target position in the automated positioning of a container on a truck. A relevant region 36 is for example divided into five smaller partial planes 38, called slices, for the 2D projection plane 18 of the 3D point cloud 16. For each of these five smaller partial planes 38, . . . the projection 8 of the 3D point cloud 16 is in each case carried out inside these partial planes 38. This procedure reduces the runtime of the algorithms. A square input vector can further be provided for further processing in the neural network. A projected partial plane 38 represents a rasterized version of the corresponding 3D point cloud 16. The partial plane 38 has pixels 40 which represent points of the projection. The, for example, five partial planes are in a further step combined to form the 2D projection plane 18 of the 3D point cloud 16. The further execution of the method in FIG. 5, in particular the further processing by means of the neural network 20 and the subsequent back-transformation into the three-dimensional space, corresponds to that in FIG. 2.

FIG. 6 shows a schematic representation of a third method for determining a target position in the automated positioning of a container on a truck. As shown in FIG. 2, a 3D point cloud 16 created by a laser scanner, in particular a 3D laser scanner, is projected into the two-dimensional space. The 2D projection plane 18 has pixels 40 which represent points of the projection. By way of example, the points are in each case assigned to three channels 42, 44, 46, wherein a first channel 42 comprises height information, a second channel 44 a remission and a third channel 46 information about surface normals. The channels 42, 44, 46 can be evaluated in combination, so that an improved accuracy can be achieved. The further execution of the method in FIG. 6, in particular the further processing by means of the neural network 20 and the subsequent back-transformation into the three-dimensional space, corresponds to that in FIG. 2.

FIG. 7 shows a schematic representation of a fourth method for determining a target position in the automated positioning of a container on a truck. Using the 3D point cloud 16 three 2D projection planes 18, 48, 50 are determined for example, which differ in respect of a projection direction. By way of example the 2D projection planes 18, 48, 50 are arranged orthogonally to one another. The 2D projection planes 18, 48, 50 each have pixels 40 which, as shown in FIG. 6, can be assigned to multiple channels 42, 44, 46, so that in each case height information, remissions and/or information about surface normals can be evaluated in the 2D projection planes 18, 48, 50. The further execution of the method in FIG. 7, in particular the further processing by means of the neural network 20 and the subsequent back-transformation into the three-dimensional space, corresponds to that in FIG. 2.

FIG. 8 shows a schematic representation of a fifth method for determining a target position in the automated positioning of a container on a truck. In addition to the partial planes 38, transition planes 52 are determined, which cover a transition region between the partial planes 38. In particular, since neural networks are more prone to error in an edge region of images and it is advisable to prevent important structures being “cut up” at the edge of a slice, it is possible to achieve an improved accuracy thanks to such transition planes 52. The further execution of the method in FIG. 7 corresponds to that in FIG. 5.

FIG. 9 shows a schematic representation of a sixth method for determining a target position in the automated positioning of a container on a truck. A 3D point cloud 16 created by a laser scanner, in particular a 3D laser scanner, is projected into the two-dimensional space. The 2D projection plane 18 has pixels 40 which represent points of the projection.

In a following step a determination 54 is carried out of at least one 2D bounding box 56, which comprises a structure to be detected. The detection of the structure is carried out by means of the neural network 20 using machine-learning algorithms of the image processing.

A further method step entails a back-projection 12 of the 2D projection plane 18 inside the at least one 2D bounding box 56 and a determination 58 of at least one 3D bounding box 60 in the 3D point cloud 16 using the at least one 2D bounding box 56. This is followed by the determination 14 of a position of the at least one structure in accordance with FIG. 1 inside the 3D bounding box 60. The further execution of the method in FIG. 9 corresponds to that in FIG. 2.

FIG. 10 shows a crane 62 with a positioning system 64. The crane 62, which among other things can be embodied as a container crane or as a gantry crane, is by way of example configured for the automated positioning of a container 66 on a truck 68. The positioning system 64 comprises laser-based sensors 70 and a control unit 72.

In summary, the invention relates to a method for determining a target position in the automated positioning 2 of a load on an object. In order to achieve improved performance and shorter calculation times in comparison with the prior art, the following steps are proposed: sensing 4 the object by means of at least one sensor 70, creating 6 a 3D point cloud 16, which represents the object, projecting 8 the 3D point cloud 16 into at least one 2D projection plane 18, detecting 10 at least one structure for the positioning of the load by means of image processing, back-projecting 12 the 2D projection plane 18 into the three-dimensional space and determining 14 a position of the at least one structure in the three-dimensional space.

1.-14. (canceled)

15. A computer-implemented method for determining a target position when automatically positioning a load on an object, the method comprising comprising:
sensing the object with a laser-based sensor;
creating a 3D point cloud representing the object;
projecting the 3D point cloud into a 2D projection plane;
detecting, using image processing by a neural network, from the 2D projection plane for positioning the load a structure constructed as a twist lock on a loading bed of a truck;
back-projecting the 2D projection plane into three-dimensional space; and
determining a position of the structure in the three-dimensional space.

16. The method of claim 15, wherein the load is a container and the object is a truck or a further container of a container mountain.

17. The method of claim 15, further comprising:
determining a 2D bounding box, which comprises the structure;
back-projecting the 2D projection plane inside the 2D bounding box,
determining a 3D bounding box in the 3D point cloud based on the 2D bounding box; and
determining a position of the structure inside the 3D bounding box.

18. The method of claim 15, further comprising comparing the 2D projection plane with training data of the neural network.

19. The method of claim 15, wherein the 2D projection plane comprises pixels to which at least one channel having height information, a remission or information about a surface normal.

20. The method of claim 15, further comprising determining at least two 2D projection planes having different projection directions.

21. The method of claim 15, wherein the 2D projection plane is composed of at least two partial planes, which are combined to form the 2D projection plane.

22. The method of claim 21, further comprising determining at least one additional transition plane, which contains a connection region of the at least two partial planes.

23. A method for automated positioning of a load on an object using the determined position of the structure, with the method as set forth in claim 15.

24. The method of claim 23, wherein the load is positioned by a crane.

25. A control unit configured to execute a method as set forth in claim 15.

26. A computer program product having computer-readable code store on a non-transitory storage medium, wherein the computer code when read into a memory a control unit and executed by a processor of the control unit, causes the control unit to execute a method as set forth in claim 15.

27. A positioning system comprising a laser-based sensor and a control unit configured to execute a method as set forth in claim 15.

28. A crane, comprising a positioning system as set forth in claim 27.
